(19) United States
(12) Patent Application Publication
(10) Pub. No.: US 2025/0168541 A1
(43) Pub. Date: May 22, 2025

(54) Mapping Method and Apparatus for Content to Be Mapped, and Storage Medium and Electronic Apparatus

(71) Applicant: ZTE Corporation, Shenzhen (CN)

(72) Inventors: Feng LIU, Shenzhen (CN); Jie CHEN, Shenzhen (CN)

(21) Appl. No.: 18/841,766

(22) PCT Filed: Dec. 19, 2022
(86) PCT No.: PCT/CN2022/140091

§ 371 Date: Aug. 27, 2024

(30) Foreign Application Priority Data
Mar. 3, 2022 (CN) 202210210117.7

(51) Int. Cl. H04Q 11/00

(52) U.S. Cl. CPC H04Q 11/0067; H04Q 2011/0088

(57) ABSTRACT

Provided are a mapping method and apparatus for content to be mapped, and a storage medium and an electronic apparatus. The method includes: determining a carrying position from a payload area of an OTN frame, and determining a sub-carrying unit located at the carrying position; sequentially extracting, from a cell stream, content to be mapped of all cells; and sequentially mapping the extracted content to be mapped into the sub-carrying unit. By using the above technical solutions, the problem in the related art of how to improve the efficiency of mapping content to be mapped in a cell carrying service is solved.

### CROSS-REFERENCE TO RELATED APPLICATION

The present disclosure is a national stage filing under 35 U.S.C. § 371 of international application number PCT/CN2022/140091, filed Dec. 19, 2022, which claims priority to Chinese Patent Application No. 202210210117.7 filed to the China National Intellectual Property Administration on Mar. 3, 2022, the disclosure of which is hereby incorporated by reference in its entirety.

### TECHNICAL FIELD

The present disclosure relates to the field of communications, and specifically to a mapping method and apparatus for content to be mapped, and a storage medium and an electronic apparatus.

### BACKGROUND

Communication networks are the highways of the information age, and changes in the content of information have led to changes in the structure of the communication networks. In the past, the content of communications was mainly voice services, and the communication networks using Synchronous Digital Hierarchy (SDH) and an Optical Transport Network (OTN) well meet the transfer of the voice services. With the development of the communication technology and the reduction of expenses, the main content carried by a current communication information network is Ethernet-structured message services, and the communication network technology is also switched to an Ethernet technology. After the latest Flex Ethernet (FlexE) technology standards are formulated, since the FlexE technology simultaneously meet carrying requirements of voice service characteristics and message service characteristics, the FlexE technology is rapidly commercialized and becomes the future development direction of the communication networks. The FlexE technology is basically based on a packet message service. A main service flow is carried by using a 66-bit code block, and when a cell is formed based on 66-bit length code blocks, how to implement the technical solution for efficient and convenient transfer in traditional OTN frames has become a research direction.

No effective solution has been proposed to the problem of how to improve the efficiency of mapping content to be mapped in a cell carrying service with respect to the related art.

Therefore, it is necessary to improve the correlation techniques to overcome the defects in the related art.

### SUMMARY

Embodiments of the present disclosure provide a mapping method and apparatus for content to be mapped, and a storage medium and an electronic apparatus, to at least solve the problem of how to improve the efficiency of mapping content to be mapped in a cell carrying service.

One aspect of the embodiments of the present disclosure provides a mapping method for content to be mapped, including: determining a carrying position from a payload area of an OTN frame, and determining a sub-carrying unit located at the carrying position; sequentially extracting, from a cell stream, content to be mapped of all cells; and sequentially mapping the extracted content to be mapped into the sub-carrying unit.

Another aspect of the embodiments of the present disclosure further provides a mapping apparatus for content to be mapped, including: a division module, configured to determine a carrying position from a payload area of an OTN frame, and determine a sub-carrying unit located at the carrying position; an extraction module, configured to sequentially extract, from a cell stream, content to be mapped of all cells; and a mapping module, configured to sequentially map the extracted content to be mapped into the sub-carrying unit.

Another aspect of the embodiments of the present disclosure further provides a computer-readable storage medium. The computer-readable storage medium stores a computer program. The computer program is configured to, when being operated, execute the mapping method for content to be mapped.

Another aspect of the embodiments of the present disclosure further provides an electronic apparatus, including a memory, a processor, and a computer program that is stored in the memory and executable on the processor. The processor executes the Al method by the computer program.

Through the present disclosure, by means of determining the carrying position from the payload area of the OTN frame, and determining the sub-carrying unit located at the carrying position; sequentially extracting, from the cell stream, content to be mapped of all the cells; and sequentially mapping the extracted content to be mapped into the sub-carrying unit, the technical problem of how to improve the efficiency of mapping content to be mapped in a cell carrying service is solved.

### BRIEF DESCRIPTION OF THE DRAWINGS

The accompanying drawings described herein are used to provide a further understanding of the present disclosure, and constitute a part of the present disclosure. The exemplary embodiments of the present disclosure and the description thereof are used to explain the present disclosure, but do not constitute improper limitations to the present disclosure. In the drawings:

FIG. 1 is a block diagram of a hardware structure of a computer terminal of a mapping method for content to be mapped according to embodiments of the present disclosure.

FIG. 2 is a flowchart of a mapping method for content to be mapped according to embodiments of the present disclosure.

FIG. 3 is a schematic diagram of a working principle of a FlexE protocol according to embodiments of the present disclosure.

FIG. 4 is a schematic diagram of timeslot and overhead blocks of a FlexE protocol according to embodiments of the present disclosure.

FIG. 5 is a schematic diagram of a process of carrying a cell on a FlexE timeslot according to embodiments of the present disclosure.

FIG. 6 is a schematic diagram of a cell structure of a 66-bit code block according to embodiments of the present disclosure.

FIG. 7 is a structural diagram of a 66-bit code block defined by an 802.3 standard according to embodiments of the present disclosure.

FIG. 8 is a schematic diagram of a cell structure according to embodiments of the present disclosure.

FIG. 9(a) is a schematic diagram (I) of a structure carrying overhead information in a cell according to embodiments of the present disclosure.

FIG. 9(b) is a schematic diagram (II) of a structure carrying overhead information in a cell according to embodiments of the present disclosure.

FIG. 10 is a schematic diagram of a Fine Grain Base Unit (FG-BU) of a communication company according to embodiments of the present disclosure.

FIG. 11 is a schematic diagram of speed adjustment by inserting an idle code block between cells according to embodiments of the present disclosure.

FIG. 12 is a schematic structural diagram of an OTN frame according to embodiments of the present disclosure.

FIG. 13 is a schematic diagram of division of sub-carrying units from a payload area of an OTN frame according to embodiments of the present disclosure.

FIG. 14 is a schematic diagram of arrangement of an idle sub-carrying unit in a payload area of an OTN frame according to embodiments of the present disclosure.

FIG. 15 is a schematic diagram of stripping of a synchronization header portion during cell mapping according to embodiments of the present disclosure.

FIG. 16 is a schematic diagram of stripping of a synchronization header and a control sub-portion during cell mapping according to embodiments of the present disclosure.

FIG. 17 is a schematic diagram of using content of an idle block as a feature value of an idle sub-carrying unit according to embodiments of the present disclosure.

FIG. 18 is a schematic diagram of using an idle block as a feature value of an idle sub-carrying unit after stripping a synchronization header according to embodiments of the present disclosure.

FIG. 19 is a schematic diagram of using specific cell overhead content as a feature value of an idle sub-carrying unit according to embodiments of the present disclosure.

FIG. 20(a) is a schematic diagram (I) of division when the size of a payload area of an OTN frame is not an integer multiple of the size of a sub-carrying unit according to embodiments of the present disclosure.

FIG. 20(b) is a schematic diagram (II) of division when the size of a payload area of an OTN frame is not an integer multiple of the size of a sub-carrying unit according to embodiments of the present disclosure.

FIG. 21 is a schematic diagram of division of sub-carrying units from payload areas of a plurality of OTN frames combined according to embodiments of the present disclosure.

FIG. 22 is a schematic diagram of a process of carrying a FG-BU of a communication company in an OTN frame according to embodiments of the present disclosure.

FIG. 23 is a schematic solution diagram (I) of an apparatus for designing a process of carrying a cell in an OTN frame according to embodiments of the present disclosure.

FIG. 24 is a schematic solution diagram (II) of an apparatus for designing a process of carrying a cell in an OTN frame according to embodiments of the present disclosure.

FIG. 25 is a schematic solution diagram (I) of a process of recovering a cell service flow in an OTN frame according to embodiments of the present disclosure.

FIG. 26 is a schematic solution diagram (II) of a process of recovering a cell service flow in an OTN frame according to embodiments of the present disclosure.

FIG. 27 is a block structural diagram of a mapping apparatus for content to be mapped according to embodiments of the present disclosure.

### DETAILED DESCRIPTION OF THE EMBODIMENTS

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those of ordinary skill in the art without creative work shall all fall within the protection scope of the present disclosure.

It is to be noted that terms “first”, “second” and the like in the description, claims and the above mentioned drawings of the present disclosure are used for distinguishing similar objects rather than describing a specific sequence or a precedence order. It should be understood that the data used in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

The method embodiments provided in the embodiments of the present disclosure may be executed in a computer terminal or a similar computing apparatus. For example, the method embodiments are operated on the computer terminal, FIG. 1 is a block diagram of a hardware structure of a computer terminal of a mapping method for content to be mapped according to embodiments of the present disclosure. As shown in FIG. 1, the computer terminal may include one or more (there is only one shown in FIG. 1) processors 102 (the processors 102 may include, but are not limited to, a Microprocessor Unit (MPU) or a Programmable Logic Device (PLD) and a memory 104 configured to store data. In an exemplary embodiment, the computer terminal may further include a transmission device 106 configured to achieve a communication function and an input/output device 108. Those skilled in the art may understand that the structure shown in FIG. 1 is only a schematic diagram, which does not limit the structure of the above computer terminal. For example, the computer terminal may further include more or less components than those shown in FIG. 1, or have different configurations that are equivalent or more functional than those shown in FIG. 1.

The memory 104 may be configured to store a computer program, for example, a software program and a module of application software, such as a computer program corresponding to a mapping method for content to be mapped in the embodiments of the present disclosure. The processor 102 runs the computer program stored in the memory 104, so as to execute various functional applications and data processing, that is, to realize the above method. The memory 104 may include a high-speed random access memory, and may further include a non-volatile memory, such as one or more magnetic disk memory apparatuses, a flash memory device, or other non-volatile solid-state memory devices. In some examples, the memory 104 may further include memories remotely disposed relative to the processor 102. The remote memories may be connected to the computer terminal by using a network. Examples of the above network include, but are not limited to, the Internet, an intranet, a local area network, a mobile communication network, and a combination thereof.

The transmission device 106 is configured to receive or send data via the network. The specific example of the above network may include a wireless network provided by a communication provider of the computer terminal. In an example, the transmission device 106 includes a Network Interface Controller (NIC), and may be connected to other network devices by using a base station, so as to communicate with the Internet. In an example, the transmission device 106 is a Radio Frequency (RF) module, which is configured to communicate with the Internet in a wireless manner.

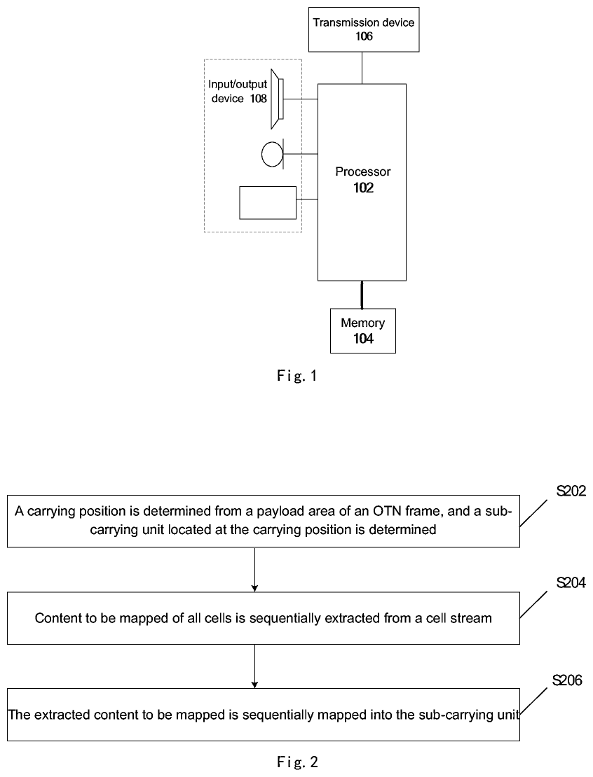

FIG. 2 is a flowchart of a mapping method for content to be mapped according to embodiments of the present disclosure. As shown in FIG. 2, the encapsulation method includes the following steps.

At S202, a carrying position is determined from a payload area of an OTN frame, and a sub-carrying unit located at the carrying position is determined.

At S204, content to be mapped of all cells is sequentially extracted from a cell stream.

At S206, the extracted content to be mapped is sequentially mapped into the sub-carrying unit.

In the embodiments of the present disclosure, by means of determining the carrying position from the payload area of the OTN frame, and determining the sub-carrying unit located at the carrying position; sequentially extracting, from the cell stream, content to be mapped of all the cells; and sequentially mapping the extracted content to be mapped into the sub-carrying unit, the problem of how to improve the efficiency of mapping content to be mapped in a cell carrying service is solved.

In an exemplary embodiment, a technical solution is further provided and specifically includes: mapping specific content into the sub-carrying unit when determining that mapping content of all the cells sequentially extracted from the cell stream is insufficient, and indicating the sub-carrying unit mapped with the specific content as an idle sub-carrying unit.

In an exemplary embodiment, in order to better understand how to determine the carrying position from the payload area of the OTN frame in S202, the carrying position may be divided from the payload area of the OTN frame.

In an exemplary embodiment, in order to better understand how to determine the carrying position from the payload area of the OTN frame in S202, a technical solution is provided and specifically includes: dividing the sub-carrying unit when determining that the size of the payload area of the OTN frame is not an integer multiple of the size of the sub-carrying unit, and then discarding a fragmented payload area obtained after the carrying position is divided from the payload area of the OTN frame.

In an exemplary embodiment, in order to better understand how to determine the carrying position from the payload area of the OTN frame in S202, the payload areas of the plurality of OTN frames may also be used as an entirety to be divided, and then the carrying position is divided from the entirety to be divided.

In an exemplary embodiment, in order to better understand how to determine the carrying position from the payload area of the OTN frame in S202, a sequence relationship between each frame in the plurality of OTN frames may be indicated by using content of an overhead field OPU OH of an Overhead Processing Unit (OPU).

In an exemplary embodiment, in order to better understand how to determine the carrying position from the payload area of the OTN frame in S202, optionally, an initial position of the first one among the sub-carrying units in each OTN frame in the payload area of the OTN frame is indicated by using content of the overhead field OPU OH of the OPU.

In an exemplary embodiment, the content to be mapped includes at least one of the following: an overall bit value of all code blocks in the cell, all byte content obtained after synchronization headers of all the code blocks in all the cells are deleted, or valid cell byte content obtained after the synchronization headers, S block control words, T block control words of all the code blocks in all the cells are deleted.

In an exemplary embodiment, a technical solution is further provided, and a specific step includes: after the synchronization headers, S block control words, T block control words of all the code blocks in all the cells are deleted, deleting required field content of control code blocks in all the cell if determining that there are invalid fields in the S block control word and/or T block control word.

In an exemplary embodiment, a technical solution of the process of mapping the specific content into the sub-carrying unit when determining that the mapping content of all the cells sequentially extracted from the cell stream is insufficient, and indicating the sub-carrying unit mapped with the specific content as the idle sub-carrying unit is proposed, and specifically includes: mapping content of an idle code block into the sub-carrying unit as the specific content, where the specific content is a flag for the idle sub-carrying unit.

In an exemplary embodiment, a technical solution of the process of mapping the specific content into the sub-carrying unit when determining that the mapping content of all the cells sequentially extracted from the cell stream is insufficient, and indicating the sub-carrying unit mapped with the specific content as the idle sub-carrying unit is proposed, and specifically includes: setting all or part of overhead fields to the specific content, where the specific content is a flag for the idle sub-carrying unit; and the specific content includes at least one of the following: 0xFF, 0x00, or other specific content that is different from normal overhead field content.

Next, the mapping method for content to be mapped is further described with reference to the drawings and the following embodiments.

The FlexE technology divides 21 timeslots, equivalent to 21 sub-physical pipelines, in a physical interface at a rate of 100G (in bits per second, similar below). The timeslots are isolated from each other, which meets voice service characteristics. Meanwhile, each sub-timeslot also uses the carrying of message service characteristics, such that the FlexE technology simultaneously meet the voice service characteristics and the message service characteristics, and the independent carrying of a voice service and a message service in one network is realized. Because of the advantages of the FlexE technology, the FlexE technology is rapidly commercialized and becomes the future development direction of communication networks after standards are published.

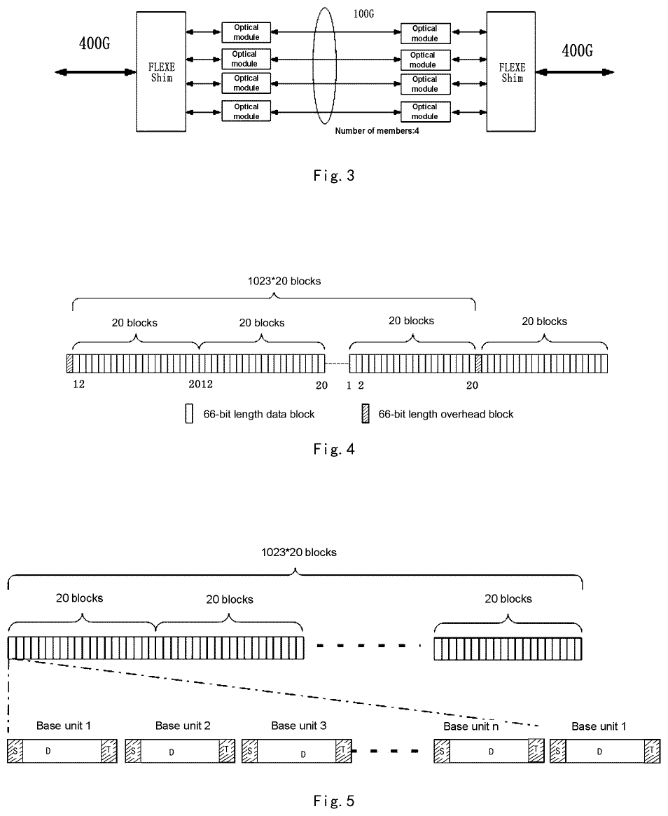

A FlexE protocol combines a plurality of 100G Ethernet interfaces together to form a large-speed transfer channel. As shown in FIG. 3, FIG. 3 is a schematic diagram of a working principle of a FlexE protocol according to embodiments of the present disclosure. In FIG. 3, 4 100G Ethernet interfaces are combined through the FlexE protocol to form a 400G transfer channel, which is equivalent to a transfer speed of 1 400G optical module, such that a transfer requirement of a 400G service is solved without increasing costs. Therefore, the transfer requirement of the 400G service is met, and the problem of an economic value of service transfer is also solved. Currently, a physical layer defined by the FlexE protocol is 100G, 21 timeslots are defined on the 100G physical layer, and each time slot corresponds to a bandwidth of 5G (bit/s) and is collectively referred to as a FlexE protocol timeslot here.

Currently, the FlexE protocol is defined according to a membership rate of 100G rate. In the optical module, before a 100G data message is sent, 64/66 encoding is first performed on a data packet message; 64-bit data is combined and then expanded into a 66-bit information block; and 2 bits added are located in front of the 66-bit block (the two bit values are fixed to “01” or “11”, “01” indicates that the information block is an information block, and “11” indicates that the information block is a control block) as a start flag of the 66-bit block, and then are sent from an optical port by means of the 66-bit block. During receiving, the optical port distinguishes the 66-bit length information block from a received data stream, and then original 64-bit data is recovered from the 66-bit length information block, so as to re-assemble the data message. The FlexE protocol is located under a 64-bit to 66-block conversion layer. Before the 66-bit information block is sent, the 66-bit information block is sorted and planned. FIG. 4 is a schematic diagram of timeslot and overhead blocks of a FlexE protocol according to embodiments of the present disclosure. As shown in FIG. 4, for a 100G (in bit per second, similar to the following terms) service, every 20 66-bit information blocks are divided into one information block group, each group has 20 information blocks, representing 20 timeslots, and each timeslot represents a service speed of a 5G bandwidth. When the 66-bit information block is sent, one FlexE overhead block (the FlexE overhead block also has a 66-bit length) is inserted each time 1023 information block groups (1023*20 information blocks) are sent, for example, black blocks in FIG. 2. After the overhead block is inserted, the information block is continuously sent; and after a second batch of 1023*20 information blocks is sent, the overhead block is then inserted, and so on. In this way, during the process of sending the information blocks, the overhead blocks are periodically inserted, and an interval of two adjacent overhead blocks is 1023*20 information blocks.

A timeslot rate provided by the FlexE technology is 5G, such that the voice service characteristics lower than a 5G rate cannot be provided. The FlexE technology is still basically based on the packet message service. A main service flow is carried by using the 66-bit code block, and the 66-bit length code blocks are required to form a cell stream, such that a voice service sub-pipeline lower than the 5G rate may be realized. FIG. 5 is a schematic diagram of a process of carrying a cell on a FlexE timeslot according to embodiments of the present disclosure. When a client service is carried on the FlexE timeslot by using a cell, as shown in FIG. 5, the client service is carried by using a cell, the cell carries sequence numbers, sequential sending is performed according to the sequence numbers, and the sequence numbers are continuously and repeatedly shown. When the client service is carried on one timeslot of the FlexE, the bandwidth of each cell is equal to 5G/n (one 5G rate is divided into n equal parts). The cell is a data combination (set) of a fixed structure, and a data structure is of various types, such as a byte set, a 11-bit block set, a 66-bit block set, a 257-bit block set, etc. The cell may also be referred to as a basic unit, a code group, a cell, etc., and cell names are used uniformly in the present disclosure for description. During implementation, the client service are selected to be carried and transferred on cells of some sequence numbers according to the magnitude of the bandwidth. When the client service has a large bandwidth, more cells are selected to carry a client; when the client service has a small bandwidth, few cells are selected to carry the client. In this way, the number of carrying cells is selected according to the magnitude of the bandwidth of the client service, so as to match the magnitude of the bandwidth of the client service with the bandwidth of a carrying pipeline. When the cell is formed by using a 66-bit block stream, since a 66-bit block structure uses an Ethernet standard, the cell formed by the 66-bit block is naturally suitable for transfer in devices of the FlexE technology and an Ethernet technology, however, how to penetrate an OTN to achieve efficient and convenient transfer in a traditional OTN frame is the technology that needs to be solved.

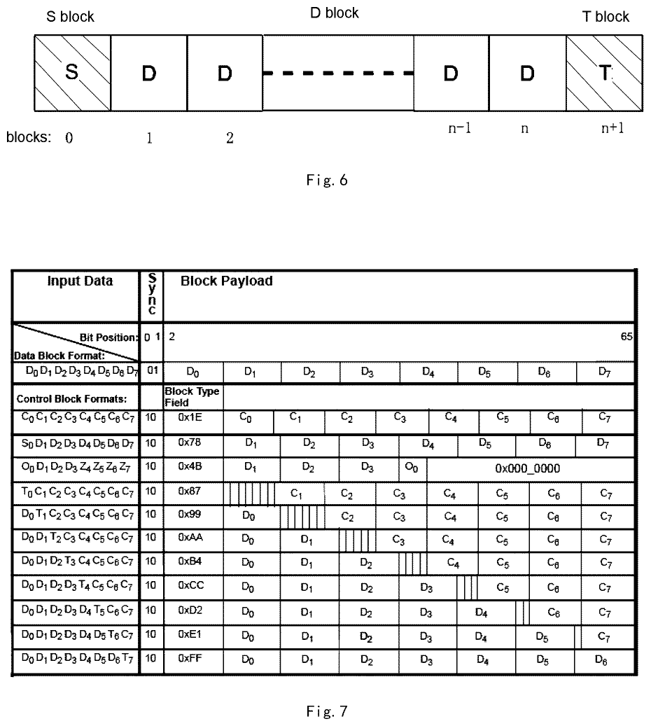

The cell is a data information value set of the fixed structure, and has a specific information start flag and a cell carrier. The cell generally has a fixed length, and a tail position of the cell may be determined according to a cell start flag and a cell length. Except that some specific cells may determine tail positions through lengths, the cell may simultaneously carry a tail flag, so as to directly determine the tail position of the cell. FIG. 6 is a schematic diagram of a cell structure of a 66-bit code block according to embodiments of the present disclosure. The cells shown in FIG. 6 are formed by code blocks followed by a 802.3 protocol 64/66 encoding rule, and each cell is formed by a plurality of 66-bit length code blocks: S block+n D blocks+T block (n is a natural number, and n is generally a fixed value). The S block is a starting block, indicating the beginning of the cell; the D block is a data block, and is configured to carry the client service; and the T block is a termination block, indicating the end of the cell. FIG. 7 is a structural diagram of a 66-bit code block defined by a 802.3 standard according to embodiments of the present disclosure. In FIG. 7, the 802.3 protocol 64/66 encoding rule is shown. Each code block is formed by 66 bits, the first 2 bits are synchronization headers of the code block, a synchronization header bit being “01” indicates that it is the D block (data code block), and the last 8 byte (64-bit) positions are 8 bytes of data content; and the synchronization header bit being “11” indicates that it is the control code block, the content of the immediately followed first one among the bytes indicates the type of the control block, the following 7 bytes are the content of the control block, and the content of the 7 bytes is determined by the type of the control block. S and T both belong to the control block, and the content of the first one among the bytes in the S block is 0x78, indicating that the current control code block is the S block. In addition to be indicated as the termination block, the T block may also carry client byte content (located at the last 7 byte positions in the code block). The T block in the Ethernet standard is divided into 8 types: T0, T1, T2, T3, T4, T5, T6, and T7. The TO (the content of the first one among the bytes is 0x87) code block does not carry client information; the T1 code block (the content of the first one among the bytes is 0x99) carries 1 byte of client information; the T2 code block (the content of the first one among the bytes is 0x99) carries 2 bytes of client information; and so on, the T7 code block (the content of the first one among the bytes is 0xFF) carries 7 bytes of client information.

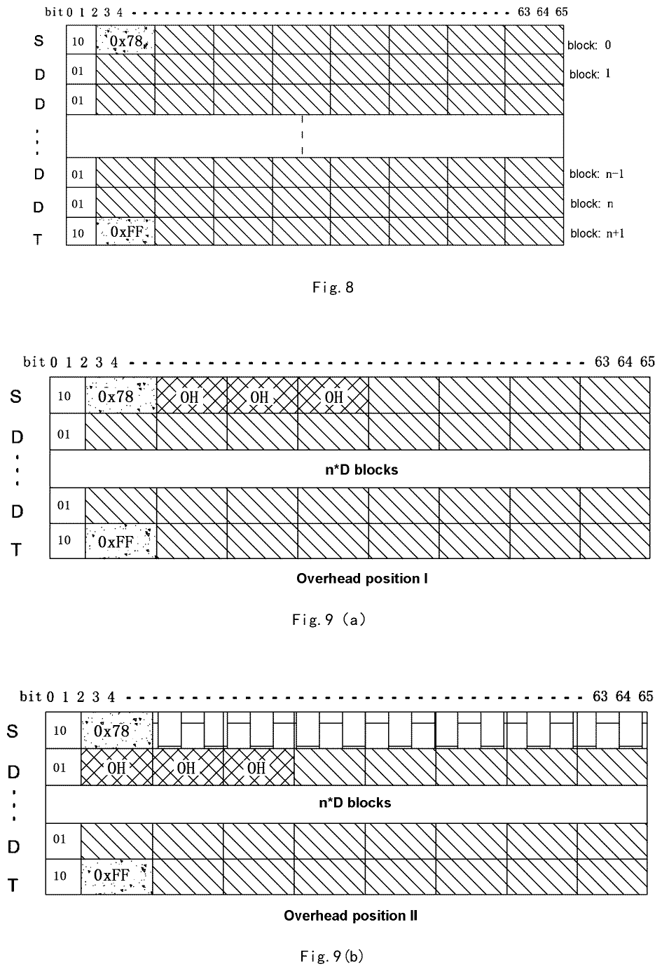

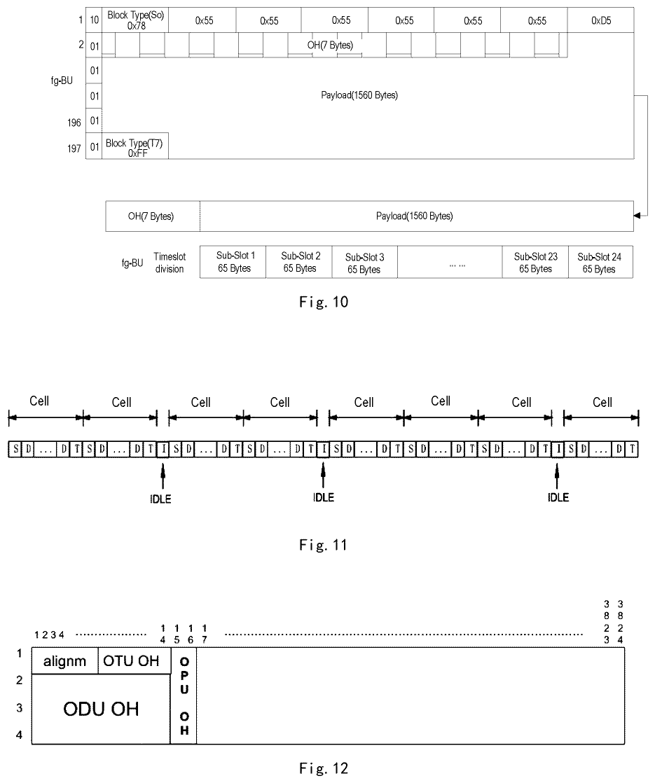

FIG. 8 is a schematic diagram of a cell structure according to embodiments of the present disclosure. A detailed structure after the cell structure defined according to S block+n D blocks+T block is expanded is shown in FIG. 8. Each row in the figure is one code block; the length of each code block is 66 bits; a first row is an S code block, the middle is a D code block, and the last one is a T code block (T7 type code block); and the first one among the bytes in the S code block and the T code block is a code block control word. Except that the D block may carry the client service, the last several bytes in the S block and the T block may also carry the client service. In addition to carrying the client service in the code block of the cell, the cell generally has overhead information, and in most cases, the overhead portion is located in a front position of the cell, and the client service is at a rear position of the cell. The overhead information is configured to indicate feature content of the cell, such as a cell version number, a serial number, a management channel information value, a negotiation information value, a check value, etc. FIG. 9(a) is a schematic diagram (I) of a structure carrying overhead information in a cell according to embodiments of the present disclosure. An overhead byte may be located at a rear position of the S block (e.g., “overhead position I” shown in FIG. 9(a)). FIG. 9(b) is a schematic diagram (II) of a structure carrying overhead information in a cell according to embodiments of the present disclosure. The overhead byte may also be located at the position of the first one among the D code blocks (e.g., “overhead position II” shown in FIG. 9(b)), the cell overhead portion shown in FIG. 9(a) and FIG. 9(b) is formed by 3 bytes, and the number of the overhead bytes may also be various lengths such as 4, 5, 6, 7, . . . . FIG. 10 is a schematic diagram of a Fine Grain Base Unit (FG-BU) of a communication company according to embodiments of the present disclosure. One application example of the cell structure is provided in FIG. 10. The example is a fine grain base service carrying unit formulated by a communication company. One FG-BU is one cell, the cell is formed by S block+195 D blocks+T block; the cell has 7 bytes of overheads, and 1560 byte carrying areas; 24 sub-timeslots are divided in the carrying areas, and each sub-timeslot is 65 bytes; and each sub-timeslot may carry one client service. 20 cells (i.e., 20 base units, from 1 to 20) form one complex frame, there are 20*24-480 sub-timeslots in the complex frame, and the bandwidth of each sub-timeslot is 10M (bit per second). 480 sub-timeslots support up to 480 sub-clients, and can support up to 480 10M Ethernet clients.

For the cell formed by the 66-bit length code blocks according to 802.3 standard protocol encoding rule, since each code block of the cell is compliant with an 802.3 protocol specification, the cell may be received and sent at a physical interface and an Ethernet physical interface of the FlexE protocol. Due to clock frequency difference among all devices on a network, rate adjustment needs to be performed when the cell is transferred on the network. When the cell passes through each device, each device needs to adjust the speed of the received cell stream to a sending clock frequency of the device, and then sends same according to the sending clock frequency of the device.

FIG. 11 is a schematic diagram of speed adjustment by inserting an idle code block between cells according to embodiments of the present disclosure. When the cell is actually sent, appropriate idle code blocks (the idle code block is an IDLE block, referred to as the I block) are inserted between the cells. As shown in FIG. 11, the idle code block is an inserted code block, which does not carry any useful information, such that the code block may be deleted during receiving, and may be inserted between the cells during sending, without affecting the normal transfer of the cell. The actual speed of the cell stream may be changed by changing the number of the idle code blocks in the cell stream. When the speed of the cell stream is less than a sending speed of a physical port, a proper number of idle blocks is inserted in the cell stream (between the front and rear cells), and the actual speed of the cell stream is accelerated (the number of cells remains unchanged) after the idle blocks are added; and when the speed of the cell stream is greater than the sending speed of a physical port, the idle blocks in the cell stream are deleted properly, and the actual speed of the cell stream is slowed down after part of the idle blocks are deleted. Since the addition or deletion operation is only for idle code blocks, the number of the cells and overall content of the cells remain unchanged, such that cell carrying content is not affected.

FlexE protocol interface devices and Ethernet devices are communication devices based on a 802.3 protocol standard. The cell formed by 66-bit blocks defined based on the 802.3 protocol may be directly carried and transferred on the FlexE protocol interface devices and Ethernet devices, but cannot be directly transferred in the OTN frame when there is an OTN device on the network. The OTN communication device is a completely different standard system based on a G.709 protocol standard and the 802.3 protocol standard, such that the cell formed by the 66-bit blocks defined based on the 802.3 protocol cannot be directly carried and transferred on the OTN device. A process of transferring the client service by the OTN includes: first mapping the client service into an Optical Playload Unit (OPU), the OPU then mapping same to an Optical Data Unit (ODU), and the ODU finally mapping same into the OTN frame for transfer. FIG. 12 is a schematic structural diagram of an OTN frame according to embodiments of the present disclosure. The structure of the OTN frame is shown in FIG. 12, and the frame is formed by 4*3824 bytes (4 rows 3824 columns). OPU overhead (OPU OH) is an OPU overhead field, and located at the Column 16-17 in the OTN frame; ODU overhead (ODU OH) is an ODU overhead field; and OTU overhead (OTU OH) is an OTU overhead field, and alignm is a frame header positioning flag. The client service is loaded and transferred in the OPU, that is, the payload area position of the OTN frame, and the payload area is located at the Column 18-3824 in the frame. How to carry the cell in the OTN frame and conveniently extract partial content of each cell, for example, for the FG-BU formulated by a communication company, there are 24 timeslots in the base unit, when the base unit is carried in the OTN frame, when a frame header position of the OTN is obtained, how to directly determine the positions of all the base units in the OTN frame, and how to directly determine the position of any one of sub-timeslots of the base unit are problems that need to be solved.

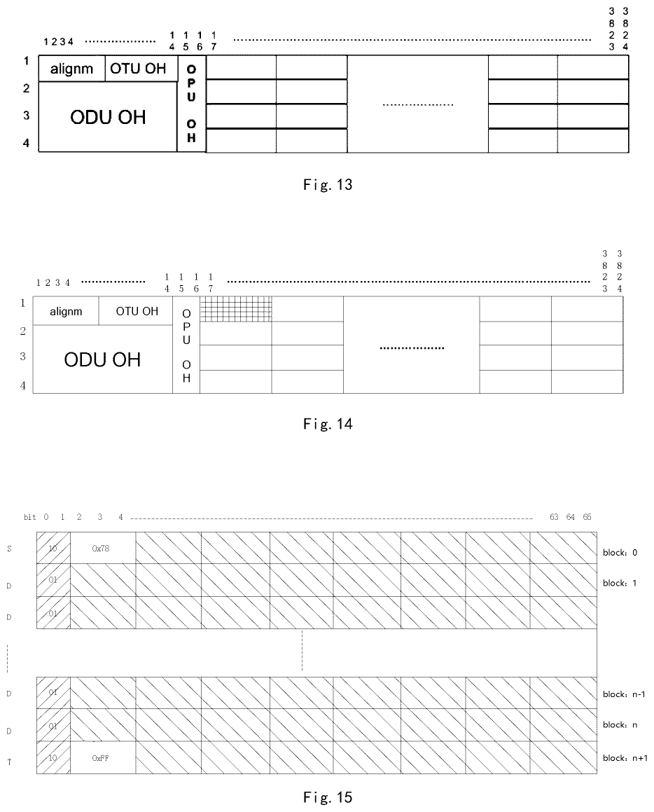

FIG. 13 is a schematic diagram of division of sub-carrying units from a payload area of an OTN frame according to embodiments of the present disclosure. In the solutions of the present disclosure, the payload area of the OTN frame is divided into sub-carrying units with equal lengths, as shown in FIG. 13, each sub-carrying unit carries one cell. When the cell is mapped in the sub-carrying units in the OTN frame (OPU), all the cell in the cell stream are extracted for mapping, and extracted content is mapped into the sub-carrying units. An extraction activity may delete all non-cell code blocks such as all the idle code blocks (if there are other non-cell code blocks, the code blocks are all deleted) in the cell stream. Since the position of each sub-carrying unit is determined, and the position of each cell (base unit) is determined, the position of each byte in each cell is determined. In this way, after the FG-BU of a communication company is mapped into the OTN frame, through the frame header position of the OTN, the position of each FG-BU may be directly determined, and the position of each sub-timeslot in each FG-BU may also be directly determined, such that the client service on each sub-timeslot is directly extracted and mapped at an OTN frame processing level, without acquiring the content of the entire FG-BU.

During the carrying of the cell, the speed of the cell code block is slower than the speed of the sub-carrying unit of the OTN frame after all the non-cell code blocks such as the idle code blocks are deleted. Speed adjustment needs to be performed when the cell is mapped to the sub-carrying unit. Part of the sub-carrying units are set to idle sub-carrying units, the positions of the idle sub-carrying units carry special content during mapping, indicated as the idle sub-carrying units. The content of the idle sub-carrying units is different from partial content of the sub-carrying units carrying the client service, such that it is easy to distinguish which carrying units are the idle sub-carrying units, and which are valid sub-carrying units. The valid sub-carrying units carry cell content, and the idle sub-carrying units do not carry the cell content. FIG. 14 is a schematic diagram of arrangement of an idle sub-carrying unit in a payload area of an OTN frame according to embodiments of the present disclosure. As shown in FIG. 14, the first one among the sub-carrying units is mapped and filled as the idle sub-carrying unit during mapping, the cell content is not mapped, and other sub-carrying units are mapped as the cell content. Since part of the sub-carrying units are filled as the idle sub-carrying units, the number of valid sub-carrying units is reduced. When the cell speed is slower, the number of cells per unit time is smaller, and more sub-carrying units are mapped as the idle sub-carrying units to adapt a slower cell speed, such that changes in the cell speed may be adapted by changing the number of the idle sub-carrying units.

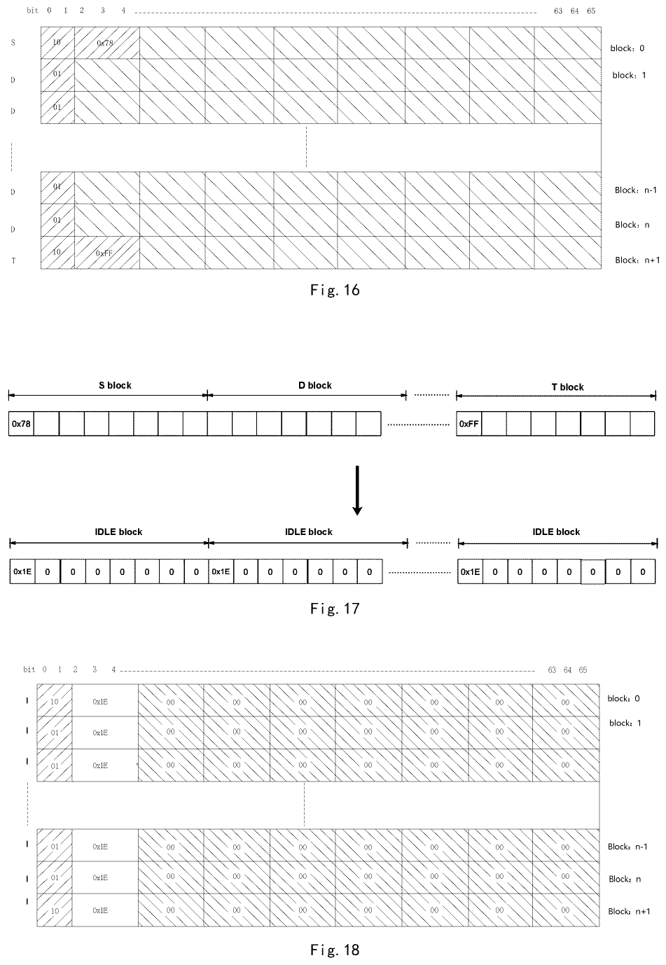

When the cell formed by the 66-bit code blocks are mapped to the sub-carrying units, the cell content needs to be extracted for mapping, and there are three extraction methods: 1, a method for entirely extracting the cell: mapping all content of the cell into the sub-carrying units, that is, (n+2)*66-bit content (content of 1 S block, content of n D blocks, and content of 1 T block, where n is a natural number) is directly mapped into the sub-carrying units; 2, a method for extracting byte content: deleting 2 bits of synchronization headers in each code block, mapping the remaining 8 bytes (64 bits, that is, 2nd-65th bit) in each code block into the sub-carrying units, where results after the 2 synchronization headers of each code block in the cell are deleted are shown in FIG. 15, FIG. 15 is a schematic diagram of stripping of a synchronization header portion during cell mapping according to embodiments of the present disclosure. 3, a method for extracting valid byte content: deleting 2 bits of synchronization headers of each code block in the cell, a control word of the S block, a control word of the T block (deleting the control word for the T7 block; deleting the control word and 1 invalid byte for T6; deleting the control word and 2 invalid bytes for T5; deleting the control word and 3 invalid bytes for T4; and so on, deleting the control word and 7 invalid bytes for T0, and deleting the bytes of the entire T block), and only reserving overhead field content in the cell and valid field content carrying client content. Results after 2 bits of synchronization headers of each code block in the cell, the control word of the S block, and the control word of the T block are shown in FIG. 16. FIG. 16 is a schematic diagram of stripping of a synchronization header and a control sub-portion during cell mapping according to embodiments of the present disclosure. In addition to the control word of the S block, invalid fields (as shown in FIG. 15, all field after the control field in the S block are all invalid content) may also be deleted together during extraction. Similarly, in addition to the control word of the T block, invalid fields may also be deleted together during mapping.

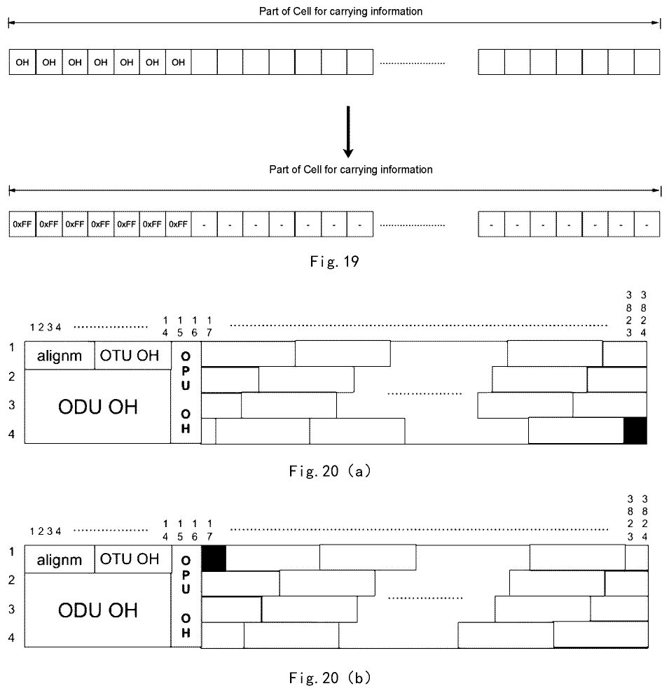

When the cell is mapped into the OTN payload area, part of the valid sub-carrying units carry the cell content, part of the sub-carrying units are the idle sub-carrying units, and the idle sub-carrying units do not carry the client content. The content of the idle sub-carrying unit has a special flag, and a flag for distinguishing the content of the valid sub-carrying unit carrying the cell, and through the special flag, the idle sub-carrying unit not carrying the cell and the valid sub-carrying unit carrying the client content are conveniently distinguished. After the sub-carrying unit carries the client content, position content of the sub-carrying unit has the features of the cell content. When the sub-carrying unit is mapped as the idle sub-carrying unit, only the feature content of the idle sub-carrying unit needs to be mapped, and the content features of the idle sub-carrying unit are different from the content features of the cell. In implementation, the content of an idle cell may be defined, the idle cell has a similar structure to a client cell, but the two cells have distinguishing flags. During mapping, if a certain sub-carrying unit needs to become the idle cell, without carrying a cell service, the content of the idle cell is directly mapped. For example, a special idle cell is defined, the content of the idle cell is n+1 IDLE blocks: a cell structure is S block+n D blocks+T block, n is a natural number, and there are n+1 66-bit code blocks in the cell. The idle cell and the client cell are similar, which both are formed by n+1 66-bit code blocks. The structure of the cell is that the first code block is an S block type, the middle code block is a D block type, and the last code block is a T block type; and the idle cell is of a structure of n+1 IDLE blocks. FIG. 17 is a schematic diagram of using content of an idle block as a feature value of an idle sub-carrying unit according to embodiments of the present disclosure. When the method for entirely extracting the cell is used, space cell content of the n+1 IDLE blocks is mapped, the content of the n+1 IDLE blocks is used as the feature of the idle sub-carrying unit, as shown in FIG. 17, the n+1 IDLE blocks are integrally mapped into the sub-carrying unit, and the sub-carrying unit is the idle sub-carrying unit. For the cell byte extraction mode, a mapping mode of 2-bit synchronization headers in the 66-bit code blocks in idle is deleted, and after the code blocks of 2-bit synchronization headers are deleted, the remaining 8 bytes are used as the features of the idle sub-carrying unit, that is, the content of the idle sub-carrying unit is n+1 8 bytes (the 8 bytes are formed by 1 0x1E byte and 7 all-zero bytes), as shown in FIG. 18. FIG. 18 is a schematic diagram of using an idle block as a feature value of an idle sub-carrying unit after stripping a synchronization header according to embodiments of the present disclosure. During specific implementation, in addition to using the n+1 IDLE blocks as the feature content of the idle sub-carrying unit, the code blocks of other types may also be used as idle cells. For example, other types of code blocks such as n+1 ERROR code blocks and n+1 O code blocks are used as the idle cells, and the content of the idle cells is extracted as the feature content of the idle sub-carrying unit. For the method for deleting 2 synchronization headers, the control word of the S block, the control word of the T block, and the invalid bytes in the extraction mode, only the overhead field and client content field of the cell are reserved after extraction, as shown in FIG. 19, FIG. 19 is a schematic diagram of using specific cell overhead content as a feature value of an idle sub-carrying unit according to embodiments of the present disclosure. Only the overhead field and client service field of the cell are mapped in the sub-carrying unit (in the figure, the content mapped to the sub-carrying unit is 7 overhead bytes and a client byte). Generally, the overhead byte of the cell is not all 0xFF content (nor will they all be 0x00), such that the position content “0xFF” of the overhead byte may be used as a feature flag of the idle sub-carrying unit (not focusing on client information location content), as shown in a lower figure in FIG. 19. In addition to using all the overhead content “0xFF” as the feature flags of the idle sub-carrying unit, the overhead portions “0x00” may also be all used as the feature flags of the idle sub-carrying unit. Other overhead content may also be defined as flag feature content of the idle sub-carrying unit, as long as any other overhead content different from normal cells may all be used as feature flag content of the idle sub-carrying unit. For example, small portion of the overhead content (not all overheads are required) “0xFF” is used as the feature flag of the idle sub-carrying unit. In application, an exclusive flag may also be set in the sub-carrying unit, and whether the sub-carrying unit is in an idle state or a state carrying the client content is determined by using the exclusive flag.

When the payload area of the OTN frame is divided into sub-carrying units with equal lengths, if the length of the payload area of the OTN frame is not an integer multiple of the length of the sub-carrying unit, most of the payload area of the OTN frame is divided into sub-carrying unit areas with equal lengths, and the remaining and fragmented areas of less than one sub-carrying unit may be abandoned for use. As shown in FIG. 20(a), the payload area of the OTN frame is divided into a large number of sub-carrying units, and the finally-remaining fragmented areas (black areas) are abandoned for use, referred to as invalid areas. In the figure, the fragmented areas abandoned for use may be located at the last position in the payload area of the OTN frame, or may also be located at the forefront of the payload area of the OTN frame. As shown in FIG. 20(b), the first one among the sub-carrying units is located behind the invalid fragmented area.

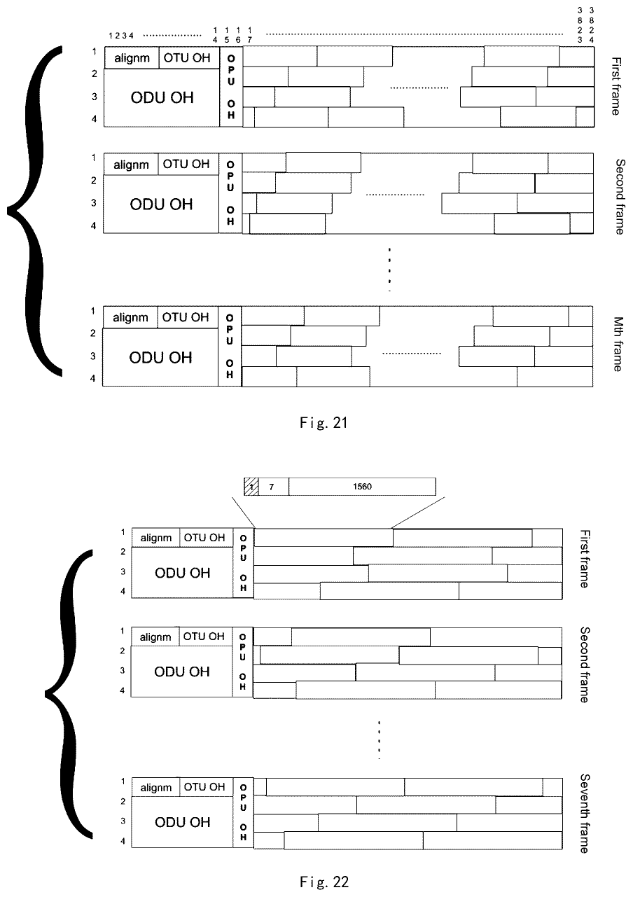

When the payload area of the OTN frame is divided into the sub-carrying units with the equal lengths, if the length of the payload area of the OTN frame is not an integer multiple of the length of the sub-carrying unit, but the lengths of the payload areas of a plurality of OTN frames are the integer multiple of the length of the sub-carrying unit, the payload areas of the plurality of OTN frames are divided into the sub-carrying units. FIG. 21 is a schematic diagram of division of sub-carrying units from payload areas of a plurality of OTN frames combined according to embodiments of the present disclosure. As shown in FIG. 21, when the payload areas of the plurality of OTN frames are divided into the sub-carrying units as a whole, a sequence relationship of the plurality of OTN frames needs to be determined, a first frame starts from that OTN frame. There is an OPU overhead field OPU OH in the OTN frame. The sequence relationship of each OTN frame may be directly provided in the OPU OH, for example, a sequence value carrying a frame in the OPU OH field. An OTN frame sequence value may not be provided during the implementation of the OPU OH, but an initial position of the first one among the complete sub-carrying units in the payload area is provided, for example, a position value carrying the sub-carrying unit in the OPU OH field. The initial position of the first one among the sub-carrying units in the payload area in the OTN frame is determined, and the positions of all the subsequent sub-carrying units are determined in sequence, such that the positions of the sub-carrying units in the subsequent OTN frame are determined.

In one embodiment, for example, for the FG-BU formulated by a communication company, the FG-BU is formed by S block+195 D blocks+T, and the valid content of the FG-BU is formed by 7 overhead bytes+1560 sub-timeslot bytes, with a total of 1567 bytes. During mapping in the OTN frame, the size of the sub-carrying unit divided in the OTN frame is 1568 bytes, such that 9 sub-carrying units may be divided in each OTN, with 1120 bytes remained. If 7 OTN frames are combined together, the sub-carrying units are divided in the 7 OTNs. FIG. 22 is a schematic diagram of a process of carrying a FG-BU of a communication company in an OTN frame according to embodiments of the present disclosure. As shown in FIG. 22, there are 7*4*3808=106624 bytes in the payload areas of the 7 OTN frames, which is exactly 68 times of 1568, such that 68 sub-carrying units may be divided in the 7 OTN frames. Each sub-carrying unit has 1568 bytes, among which 1 byte is idle for use, 7 bytes carry 7 bytes of the FG-BU, and 1560 bytes carry byte content of 24 sub-timeslots. When the content of the FG-BU is mapped, only the overhead of the FG-BU and the content of the 24 sub-timeslots are carried, and content of the synchronization header of the code block, control word of the S block, and control word of the T block is not carried. Through such carrying, the position of each FG-BU, as well as the position of each sub-timeslot in each FG-BU, may be determined, as long as the OTN frame header position and frame sequence relationship are determined. Therefore, the client service of each sub-timeslot is conveniently extracted from the position of the OTN frame, and the client service of each sub-timeslot is conveniently directly mapped, such that the FG-BU can map the sub-timeslots without processing.

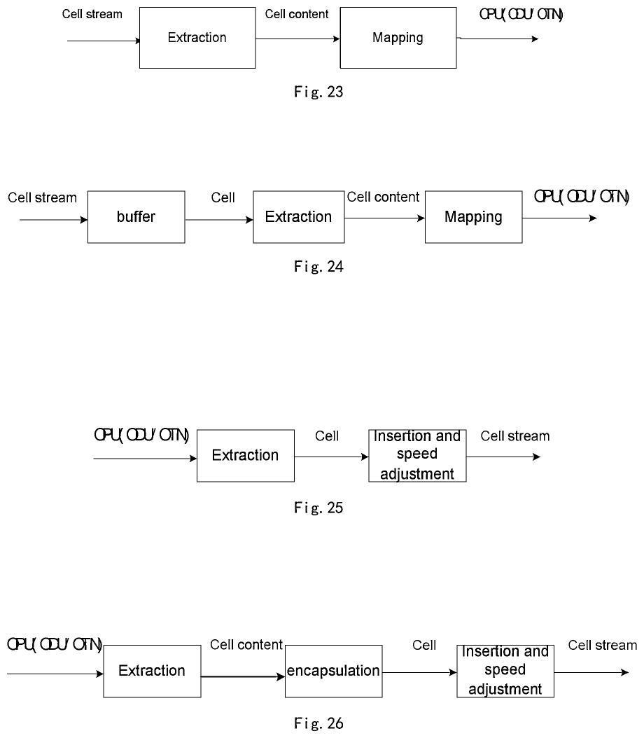

The process of carrying the cell in the OTN frame is shown in FIG. 23. The carrying process includes at least two apparatuses. The first apparatus is an extraction apparatus, which is configured to extract the cell and the cell content from the cell streams, delete the IDLE code block and O code block in the cell stream during extraction, and extract the overall cell content. If the content of the 2-bit synchronization headers of the 66-bit code blocks is not included during extraction, after extracting the cell, the extraction apparatus further extracts the last 8 bytes (64 bits) in each code block, and deletes the 2-bit synchronization headers in each code block. If the content of the control words of the S block and T block is not included during extraction, when extracting, the extraction apparatus deletes the content of the 2-bit synchronization headers in each code block, and the control word portions of the S block and T block (deleting the control word for the T7 block; deleting the control word and 1 invalid byte for T6; deleting the control word and 2 invalid bytes for T5; deleting the control word and 3 invalid bytes for T4; and so on, deleting the control word and 7 invalid bytes for T0). If there are invalid bytes in the S block and T block, the invalid bytes are deleted at the same time, and only cell overhead field content in the cell and valid field content carrying the client content are reserved for mapping. A mapping apparatus maps the mapped cell content, and sequentially maps the cell content into each sub-carrying unit in the OTN frame. When the number of the cell is insufficient during the mapping process, the positions of part of the sub-carrying units are mapped as the feature content of the idle sub-carrying units, and the corresponding sub-carrying units become the idle sub-carrying units, without mapping the client cell content. In specific application, in addition to the extraction apparatus and the mapping apparatus, FIG. 24 is a schematic solution diagram (II) of an apparatus for designing a process of carrying a cell in an OTN frame according to embodiments of the present disclosure, a cache apparatus shown in FIG. 24 may also be added. The cache apparatus may be located before the extraction apparatus, or may also be located behind the extraction apparatus, and FIG. 24 only shows the cache apparatus located before the extraction apparatus. The cache apparatus implements the temporary caching of the cell, the number of the idle sub-carrying units in the OTN frame is determined according to a cache depth, and the positions of the idle sub-carrying units may be planned in advance.

An apparatus structure of a sending device is provided above, and the sending device maps the cell to the OTN frame, and then send same out. In a receiving device, an original cell needs to be recovered after receiving the OTN frame, and an apparatus recovering the cell stream is shown in FIG. 25. FIG. 25 is a schematic solution diagram (I) of a process of recovering a cell service flow in an OTN frame according to embodiments of the present disclosure. The extraction apparatus first extracts the position content (excluding the idle sub-carrying units) of the sub-carrying units in the OTN frame. If the mapping is the overall mapping of the cells, the original cell is obtained after extraction, and then an insertion speed adjustment apparatus inserts the idle code blocks between the cells, performs speed adjustment on the cell stream, and then sends same out. If the mapping is the mapping that is performed after the 2-bit synchronization headers of the cell, or the 2-bit synchronization headers as well as the control words (which may also include invalid content behind the control fields) of the S code block and T code block are deleted, the extraction apparatus only extracts partial content of the cell from the OTN frame, and needs to pass through a packaging apparatus, as shown in FIG. 26. FIG. 26 is a schematic solution diagram (II) of a process of recovering a cell service flow in an OTN frame according to embodiments of the present disclosure. The content deleted during mapping is packaged to recover the overall content of the original cell, and finally the proper number of idle code blocks is inserted in the cell by the insertion speed adjustment apparatus, and sent out after speed adjustment.

The above embodiments may have various different specific forms in different application scenarios and different specific device forms, and these different forms are all within the scope of protection of the present disclosure.

From the above descriptions about the implementation modes, those skilled in the art may clearly know that the method according to the foregoing embodiments may be implemented in a manner of combining software and a necessary universal hardware platform, and of course, may also be implemented through hardware, but the former is a preferred implementation mode under many circumstances. Based on such an understanding, the technical solutions of the present disclosure substantially or parts making contributions to the conventional art may be embodied in form of software product, and the computer software product is stored in a storage medium (for example, a ROM/RAM), a magnetic disk and an optical disk), including a plurality of instructions configured to enable a terminal device (which may be a mobile phone, a computer, a server, a network device, or the like) to execute the method in each embodiment of the present disclosure.

This embodiment further provides a mapping apparatus for content to be mapped. The apparatus is configured to implement the foregoing embodiments and the preferred implementation, and what has been described will not be described again. As used below, the term “module” may be a combination of software and/or hardware that implements a predetermined function. Although the device described in the following embodiments is preferably implemented in software, but implementations in hardware, or a combination of software and hardware, are also possible and conceived.

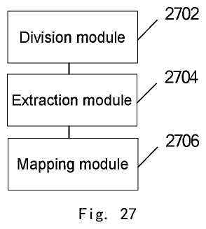

FIG. 27 is a block structural diagram of a mapping apparatus for content to be mapped according to embodiments of the present disclosure. As shown in FIG. 27, the mapping apparatus for content to be mapped includes a division module, an extraction module, and a mapping module.

The division module 2702 is configured to determine a carrying position from a payload area of an OTN frame, and determine a sub-carrying unit located at the carrying position.

The extraction module 2704 is configured to sequentially extract, from a cell stream, content to be mapped of all cells.

The mapping module 2706 is configured to sequentially map the extracted content to be mapped into the sub-carrying unit.

Through the above apparatus, by means of determining the carrying position from the payload area of the OTN frame, and determining the sub-carrying unit located at the carrying position; sequentially extracting, from the cell stream, content to be mapped of all the cells; and sequentially mapping the extracted content to be mapped into the sub-carrying unit, the problem of how to improve the efficiency of mapping content to be mapped in a cell carrying service is solved.

In an exemplary embodiment, the apparatus further includes a mapping module, configured to map specific content into the sub-carrying unit when determining that mapping content of all the cells sequentially extracted from the cell stream is insufficient, and indicate the sub-carrying unit mapped with the specific content as an idle sub-carrying unit.

In an exemplary embodiment, the division module is further configured to divide the carrying position from the payload area of one OTN frame.

In an exemplary embodiment, the division module is further configured to divide the sub-carrying unit when determining that the size of the payload area of the OTN frame is not an integer multiple of the size of the sub-carrying unit, and then discard a fragmented payload area obtained after the carrying position is divided from the payload area of the OTN frame.

In an exemplary embodiment, the division module is further configured to use payload areas of a plurality of OTN frames as an entirety to be divided, and divide the carrying position from the entirety to be divided.

In an exemplary embodiment, the division module is further configured to indicate a sequence relationship between each frame in the plurality of OTN frames by using content of an overhead field OPU OH of an OPU.

In an exemplary embodiment, the division module is further configured to indicate an initial position of the first one among the sub-carrying units in each OTN frame in the payload area of the OTN frame by using content of an overhead field OPU OH of an OPU.

In an exemplary embodiment, the content to be mapped includes at least one of the following: an overall bit value of all code blocks in the cell, all byte content obtained after synchronization headers of all the code blocks in all the cells are deleted, or valid cell byte content obtained after the synchronization headers, S block control words, T block control words of all the code blocks in all the cells are deleted.

In an exemplary embodiment, the apparatus further includes a deletion module, configured to, after the synchronization headers, S block control words, T block control words of all the code blocks in all the cells are deleted, delete required field content of control code blocks in all the cell if determining that there are invalid fields in the S block control word and/or T block control word.

In an exemplary embodiment, the mapping module is further configured to map content of an idle code block into the sub-carrying unit as the specific content, where the specific content is a flag for the idle sub-carrying unit.

In an exemplary embodiment, the mapping module is further configured to set all or part of overhead fields to the specific content. The specific content is a flag for the idle sub-carrying unit; and the specific content includes at least one of the following: 0xFF, 0x00, or other specific content that is different from normal overhead field content.

In an exemplary embodiment, the computer-readable storage medium may include, but is not limited to, a USB flash disk, a Read-Only Memory (ROM), a Random Access Memory (RAM), and various media that can store computer programs, such as a mobile hard disk, a magnetic disk, or an optical disk.

For specific examples in this embodiment, refer to the examples described in the foregoing embodiments and the exemplary implementations, and this embodiment will not be repeated thereto.

An embodiment of the present disclosure further provides an electronic apparatus. The electronic apparatus includes a memory and a processor. The memory is configured to store a computer program. The processor is configured to run the computer program to execute steps in any one of method embodiments described above.

Optionally, in this embodiment, the processor may be configured to perform the following steps through the computer program.

At S1, a carrying position is determined from a payload area of an OTN frame, and a sub-carrying unit located at the carrying position is determined.

At S2, content to be mapped of all cells is sequentially extracted from a cell stream.

At S3, the extracted content to be mapped is sequentially mapped into the sub-carrying unit.

In an exemplary embodiment, the electronic apparatus may further include a transmission device and an input/output device. The transmission device is connected to the processor. The input/output device is connected to the processor.

For specific examples in this embodiment, refer to the examples described in the foregoing embodiments and the exemplary implementations, and this embodiment will not be repeated thereto.

It is apparent that those skilled in the art should understand that the above mentioned modules or steps of the present disclosure may be implemented by a general computing device, and may also be gathered together on a single computing device or distributed in network composed of multiple computing devices. The above mentioned modules or steps of the present application may be implemented with program codes executable by the computing device, so that may be stored in a storage device for execution by the computing device, and in some cases, the steps shown or described may be performed in a different sequence than herein, or can be fabricated into individual integrated circuit modules respectively, or multiple modules or steps thereof are fabricated into a single integrated circuit module for implementation. In this way, the present disclosure are not limited to any specific combination of hardware and software.

The above are only the preferred embodiments of the present disclosure and are not intended to limit the present disclosure. For those skilled in the art, the present disclosure may have various modifications and variations. Any modifications, equivalent replacements, improvements and the like made within the principle of the disclosure shall fall within the scope of protection of the present disclosure.

1. A mapping method for content to be mapped, comprising:
determining a carrying position from a payload area of an Optical Transport Network (OTN) frame, and determining a sub-carrying unit located at the carrying position;
sequentially extracting, from a cell stream, content to be mapped of all cells; and
sequentially mapping the extracted content to be mapped into the sub-carrying unit.

2. The mapping method according to claim 1, further comprising:
mapping specific content into the sub-carrying unit when determining that mapping content of all the cells sequentially extracted from the cell stream is insufficient, and indicating the sub-carrying unit mapped with the specific content as an idle sub-carrying unit.

3. The mapping method according to claim 1, wherein determining the carrying position from the payload area of the OTN frame comprises:
dividing the carrying position from the payload area of one OTN frame.

4. The mapping method according to claim 3, wherein determining the carrying position from the payload area of the OTN frame comprises:
dividing the sub-carrying unit when determining that the size of the payload area of the OTN frame is not an integer multiple of the size of the sub-carrying unit, and then discarding a fragmented payload area obtained after the carrying position is divided from the payload area of the OTN frame.

5. The mapping method according to claim 1, wherein determining the carrying position from the payload area of the OTN frame comprises:
using payload areas of a plurality of OTN frames as an entirety to be divided, and dividing the carrying position from the entirety to be divided.

6. The mapping method according to claim 5, wherein determining the carrying position from the payload area of the OTN frame comprises:
indicating a sequence relationship between each frame in the plurality of OTN frames by using content of an overhead field OPU OH of an Overhead Processing Unit (OPU).

7. The mapping method according to claim 5, wherein determining the carrying position from the payload area of the OTN frame comprises:
indicating an initial position of the first one among the sub-carrying units in each OTN frame in the payload area of the OTN frame by using content of an overhead field OPU OH of an OPU.

8. The mapping method according to claim 1, wherein the content to be mapped comprises at least one of the following: an overall bit value of all code blocks in the cell, all byte content obtained after synchronization headers of all the code blocks in all the cells are deleted, or valid cell byte content obtained after the synchronization headers, S block control words, T block control words of all the code blocks in all the cells are deleted.

9. The mapping method according to claim 8, further comprising:
after the synchronization headers, S block control words, T block control words of all the code blocks in all the cells are deleted, deleting required field content of control code blocks in all the cell if determining that there are invalid fields in the S block control word and/or T block control word.

10. The mapping method according to claim 2, wherein in the process of mapping the specific content into the sub-carrying unit when determining that the mapping content of all the cells sequentially extracted from the cell stream is insufficient, and indicating the sub-carrying unit mapped with the specific content as the idle sub-carrying unit, the method further comprises:
mapping content of an idle code block into the sub-carrying unit as the specific content, wherein the specific content is a flag for the idle sub-carrying unit.

11. The mapping method according to claim 2, wherein in the process of mapping the specific content into the sub-carrying unit when determining that the mapping content of all the cells sequentially extracted from the cell stream is insufficient, and indicating the sub-carrying unit mapped with the specific content as the idle sub-carrying unit, the method further comprises:
setting all or part of overhead fields to the specific content, wherein the specific content is a flag for the idle sub-carrying unit; and the specific content comprises at least one of the following: 0xFF, 0x00, or other specific content that is different from normal overhead field content.

12. A mapping apparatus for content to be mapped, comprising:
a division module, configured to determine a carrying position from a payload area of an Optical Transport Network (OTN) frame, and determine a sub-carrying unit located at the carrying position;
an extraction module, configured to sequentially extract, from a cell stream, content to be mapped of all cells; and
a mapping module, configured to sequentially map the extracted content to be mapped into the sub-carrying unit.

13. A non-transitory computer-readable storage medium, having a computer program stored therein, wherein the computer program is configured to perform, when being executed by an processor, the method as claimed in claim 1.

14. An electronic apparatus, comprising a memory and a processor, wherein the memory stores a computer program; and the processor is configured to execute the computer program to:
determine a carrying position from a payload area of an Optical Transport Network (OTN) frame, and determining a sub-carrying unit located at the carrying position;
sequentially extract, from a cell stream, content to be mapped of all cells; and
sequentially map the extracted content to be mapped into the sub-carrying unit.

15. The electronic apparatus according to claim 14, the processor is further configured to:
map specific content into the sub-carrying unit when determining that mapping content of all the cells sequentially extracted from the cell stream is insufficient, and indicate the sub-carrying unit mapped with the specific content as an idle sub-carrying unit.

16. The electronic apparatus according to claim 14, the processor is further configured to:
divide the carrying position from the payload area of one OTN frame.

17. The electronic apparatus according to claim 16, the processor is further configured to:
divide the sub-carrying unit when determining that the size of the payload area of the OTN frame is not an integer multiple of the size of the sub-carrying unit, and then discard a fragmented payload area obtained after the carrying position is divided from the payload area of the OTN frame.

18. The electronic apparatus according to claim 14, the processor is further configured to:
use payload areas of a plurality of OTN frames as an entirety to be divided, and divide the carrying position from the entirety to be divided.

19. The electronic apparatus according to claim 18, the processor is further configured to:
indicate a sequence relationship between each frame in the plurality of OTN frames by using content of an overhead field OPU OH of an Overhead Processing Unit (OPU).

20. The electronic apparatus according to claim 14, wherein the content to be mapped comprises at least one of the following: an overall bit value of all code blocks in the cell, all byte content obtained after synchronization headers of all the code blocks in all the cells are deleted, or valid cell byte content obtained after the synchronization headers, S block control words, T block control words of all the code blocks in all the cells are deleted.
